(19) United States
(12) Patent Application Publication
(10) Pub. No.: US 2003/0023456 A1
(43) Pub. Date: Jan. 30, 2003

(54) System and method for enabling retail sales to international travellers

(76) Inventors: Michael R. Dilollo, Ottawa (CA); Ian C. W. Lovsin, Navan (CA)

Correspondence Address: Welsh & Katz, Ltd., Eric D. Cohen, 22nd Floor, 120 South Riverside Plaza, Chicago, IL, 60606, US

(21) Appl. No.: 10/198,906

(22) Filed: Jul. 19, 2002

Related U.S. Application Data
(60) Provisional application No. 60/306,411, filed on Jul. 20, 2001.

(51) Int. Cl. G06F 17/60

(52) U.S. Cl. 705/1; 705/26

(57) ABSTRACT

The present invention provides a system for enabling the purchase of retail goods at one location and the delivery of those retail goods at a second location. This type of system is particularly adapted for the use in the field of “dutyfree” or “tax free” purchases, wherein a product purchased by an individual at a first location, for example the point of departure of the individual or on board the mode of transportation, can be collected upon arrival at the destination point, wherein the departure and destination points are separated by at least one international border. The system is enabled by three key components, one or more browsing devices, an administration device and a communication network to provide interconnection between the one or more browsing devices and the administration device. An individual uses the browsing device to view, identify and select one or more retail goods for purchase. Information provided by the individual, for example, selected retail goods and personal monetary information and travel itinerary, is transmitted via the communication network to the administration device. The administration device coordinates the transfer of funds relating to the retail goods purchased, in addition to the delivery of the selected retail goods to the destination of the individual. The individual, upon arrival at their destination, can collect their purchased retail goods at a predetermined, pre-customs location.

### CROSS-REFERENCE TO RELATED APPLICATIONS

This application claims the benefit of priority from copending provisional patent application Serial No. 60/306,411 filed on Jul. 20, 2001, entitled “Method and Apparatus for Enabling Retail Sales to International Travellers.” Provisional patent application Serial No. 60/306,411 is incorporated herein by reference in its entirety.

### FIELD OF THE INVENTION

The present invention pertains to a system and method for enabling retail sales to international travellers.

### BACKGROUND

The present invention involves the retail sale of goods which are offered to international travellers at prices excluding import duties (“duty free”) or provide for the rebate of taxes paid (“tax free”). Travel retail goods are traditionally sold at airports, seaports, as well as onboard aircraft, on ferries and at international land border crossings—wherever international travel takes place.

One example of travel retail goods is “duty free” goods sold at “duty free” shops. Most “duty free” shops fall into one of two categories, outwards shops and inwards shops. Outwards “duty free” shops sell goods “duty” and “tax-free” at the point of departure to travellers leaving a particular country. These stores are usually located in the departure areas of the international airports, but they may be off-site as well. Inwards “duty free” shops are shops licensed to sell travel retail goods at the point of arrival only to travellers arriving in a particular country, typically on an international flight. Inwards “duty free” shops are usually positioned between passenger disembarkation and Customs and Immigration processing.

Travel retail shopping embraces all kinds of consumer products, including alcohol, tobacco, perfumery, confectionery, electronics, for example, in a US $20 billion industry catering to 500 million travellers annually. This includes “duty free” sales. There are more than 2,000 “duty free” retail shop operators worldwide and almost 5,000 manufacturers offering some 12,000 brands and more than 250,000 products.

The current business model for the sale of travel retail goods is focussed largely on the sale of travel retail goods at the point of the departure in outwards “duty free” shops. Under this business model, a traveller will enter a travel retail store at the point of departure and make a purchase. The traveller will then carry the travel retail purchase with him/her on the plane (or boat or other means of transportation) to the destination.

In so doing, a traveller must either tuck travel retail purchases under a seat, which can impact on leg room, or in overhead compartments that are frequently full of other passengers' carry-on luggage and purchases. Of course, this increases the risk of breakage. For example, a bottle of “duty free” perfume or liquor that breaks during an aircraft flight is a disappointing loss for the traveller and problematic for the airline, which may have to take the aircraft out of service for exhaustive spillage checks and cleanup. As well, airlines must incur additional fuel costs and additional baggage requirements in transporting “duty free” product carts and “duty free” purchases made by travellers.

Furthermore, the services just described are performed manually by the attendants or crew of the vehicle. For example, money for liquor sales or duty-free sales may be collected by an airline flight attendant who makes change from money in a small pouch or even from a pocket in the clothing. Credit card transactions may require a customer to relinquish the card to an attendant who takes the card to another part of the vehicle for processing. These manual transactions are time-consuming, error prone, and often times do not provide a desirable professional image for the service provider. In addition, duty-free sales are governed by Customs' rules and regulations which make it essential to maintain proper inventory and sales records of duty-free items.

The on-board sale of travel retail purchases by airlines and cruise ship operators also suffers from weaknesses. These include additional costs associated with the administration of complicated product handling logistics, added fuel consumption costs due to the increased weight of on-board “duty free” carts, limited on-board selection and quantity, and recurring problems with breakage, theft, and illegal on-board consumption of purchased travel retail alcohol products, which create problems for other passengers and flight crews. For example, airlines experience significant additional costs and aircraft downtime when aircraft must be pulled from service for rigorous inspection because of travel retail products spillage and breakage during flights. Another drawback is that the in-flight travel retail shopping experience is typically rushed, noisy and the selection may be limited.

Inwards travel retail shops, which are usually placed between passenger disembarkation and Customs and Immigration processing, also suffer from shortcomings as a business model for the sale of travel retail goods. Upon disembarkation at the point of arrival, passengers are usually in a hurry to complete Customs and Immigration processing and often do not have the patience to select and pay for a travel retail purchase. As a result of their reduced sales, inwards travel retail shops are far more rare worldwide than outwards travel retail shops, where passengers typically have the time before departure to shop.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for enabling retail sales to international travellers. In accordance with an aspect of the present invention, there is provided a system enabling the sale of retail goods to one or more individuals travelling from a departure point to a destination point, the system comprising: one or more browsing devices enabling an individual to view, identify and select one or more retail goods for purchase; an administration device for processing one or more purchase orders of the one or more individuals, the administration device being interconnected to one or more databases, the administration device being located at the destination point; and a communication network for interconnecting the one or more browsing devices and the administration device; wherein the departure point and the destination point are separated by one or more international borders and wherein the one or more individuals claim the purchased retail goods at a pre-customs location at the destination point.

In accordance with another aspect of the invention, there is provided a system enabling the sale of retail goods to one or more individuals travelling from a departure point to a destination point, the system comprising: one or more browsing devices enabling an individual to view, identify and select one or more retail goods for purchase; a destination device enabling the distribution of purchased retail goods, the destination device being located at the destination point; an administration device for processing one or more purchase orders of the one or more individuals, the administration device being interconnected to one or more databases, the administration device relaying information from the one or more browsing devices to the destination device, the administration device being located at a point removed from both the departure point and the destination point; a first communication network for interconnecting the one or more browsing devices and the administration device; a second communication network for interconnecting the administration device and the destination device; wherein the departure point and the destination point are separated by one or more international borders and wherein the one or more individuals claim the purchased retail goods at a pre-customs location at the destination point.

In accordance with another aspect of the invention, there is provided a kiosk for use in the sale of travel retail goods to a purchaser, the kiosk being proximate to a port at a point of departure for said purchaser, said kiosk comprising: an input; a display screen; and communications means; whereby upon the entering of an order for travel retail goods by the purchaser, data associated with the order is sent via the communication means for fulfillment at location B, location B being proximate to a port at a point of arrival for said purchaser.

In accordance with another aspect of the invention there is provided a satellite communication device for use in the sale of travel retail goods to a purchaser, the satellite communication device being on-board a mode of transportation for said purchaser, said satellite communication device comprising: an input; a display screen; and satellite communications means; whereby upon the entering of an order for travel retail goods by the purchaser, data associated with the order is sent via the satellite communication means for fulfillment at location B, location B being proximate to a port at a point of arrival for said purchaser.

In accordance with another aspect of the invention there is provided a computer readable medium storing processor executable instructions that when loaded at a kiosk or satellite communication device at location A adapt said kiosk or satellite communication device to, display on a display screen a range of travel retail goods available for sale; enable a selection by the purchaser of one or more of said range of travel retail goods; confirm delivery at location B of the travel retail goods selected by the purchaser; receive payment details from the purchaser; forward order data to location B, the order data including details of the travel retail goods selected by the purchaser available from inventory a location B and the payment details received from the purchaser; and provide the purchaser with an electronic claim ticket for use at location B.

In accordance with another aspect of the invention there is provided a method of enabling the sale of travel retail goods comprising the steps of: accepting from a purchaser an order for the sale of travel retail goods at location A; and fulfilling the order for travel retail goods at location B, location B being proximate to a port at a point of arrival for said purchaser.

In accordance with another aspect of the invention there is provided a method of enabling the sale of travel retail goods comprising the steps of: accepting from a purchaser an order for the sale of travel retail goods on-board a mode of transportation travelling from a point of departure to a point of arrival; and fulfilling the order for travel retail goods at the point of arrival for said mode of transportation.

In one aspect of the present invention there is provided a method and apparatus for enabling travel retail sales where the point of sale is at a first location and the point of fulfillment for the travel retail goods is at a location proximate to the point of arrival. A browsing device, such as a kiosk modelled on the design characteristics of an Automatic Teller Machine (ATM), can be used by the traveller for order entry. Order entry can also be accomplished via the Internet through a web site on the world wide web. The physical location where order entry takes place is arbitrary. It could be proximate to the departure port, or at a travel agent office, or at some other location.

In another aspect of the present invention there is provided a method and apparatus for enabling travel retail sales where the point of sale is at a location on-board a mode of transportation and the point of fulfillment for the travel retail goods is at a location proximate to the point of arrival of the traveller. A device (such as a phone or electronic Personal Digital Assistant or other interface) available on-board a mode of transportation, either alone or connected to a passenger's laptop computer may function as a browsing device. This browsing device may be interconnected to an administration device through the use of a satellite communication system, for example. Through the use of this type of technology, the on-board cabin of a mode of transport can be transformed into an electronic, multi-media showcase of travel retail goods available for pickup by a traveller after disembarkation at the point of arrival.

The use of either aspect of the present invention allows transportation operators such as airlines to lower flight operating costs, offer additional seating space by eliminating travel retail baggage and on-board travel retail products. The present invention may lighten payloads, saves fuel costs and may free stewards to complete primary tasks.

The use of either aspect of the present invention may allow the travel retail product channels to widen since suppliers of travel retail goods may be freed of many of the physical constraints that limit the breadth of products they can showcase to travellers, either in outwards shops, or inwards shops on-board the mode of transportation. Through on-board communication links or land-based connections between the devices at the point of sale and devices at the point of order fulfillment, travellers may have real-time access and exposure to a full line of a travel retail supplier's products.

### BRIEF DESCRIPTION OF THE FIGURES

FIG. 1 illustrates a schematic diagram illustration the various elements of the system according to one embodiment of the present invention.

FIG. 2 illustrates a public access terminal (PAT) which can be incorporated into the system according to one embodiment of the present invention.

FIG. 3 illustrates a public access terminal as shown in FIG. 3, mounted on a stand.

FIG. 4 illustrates a schematic diagram of a multi-channel aviation satellite communication system, which may be incorporated into one embodiment of the present invention.

FIG. 5 illustrates a schematic diagram of the system according to one embodiment of the present invention.

FIG. 6 illustrates a schematic diagram of the system according to a second embodiment of the present invention.

FIG. 7 illustrates a schematic diagram of the system according to a third embodiment of the present invention.

FIG. 8 illustrates a schematic diagram of the system according to a fourth embodiment of the present invention.

FIG. 9 is a schematic flowchart of steps undertaken by a purchaser when purchasing travel retail goods in accordance with one embodiment of the invention.

FIG. 10 is a data flow diagram for the steps shown in FIG. 1.

FIG. 11 is a schematic flowchart of steps undertaken by a purchaser when purchasing travel retail good in accordance with another embodiment of the invention.

FIG. 12 is a schematic flowchart of steps undertaken by a purchaser when purchasing travel retail good in accordance with another embodiment of the invention.

FIG. 13 is a data flow diagram of information between a browsing device, the administration device and a destination device according to one embodiment of the invention.

### DETAILED DESCRIPTION OF THE INVENTION

The present invention provides a system for enabling the purchase of retail goods at one location and the delivery of those retail goods at a second location. This type of system is particularly adapted for the use in the field of “dutyfree” or “tax free” purchases, wherein a product purchased by an individual at a first location, for example the point of departure of the individual or on board the mode of transportation, can be collected upon arrival at the destination point, wherein the departure and destination points are separated by at least one international border. The system is enabled by three key components, one or more browsing devices, an administration device and a communication network to provide interconnection between the one or more browsing devices and the administration device. An individual uses the browsing device to view, identify and select one or more retail goods for purchase. Information provided by the individual, for example, selected retail goods and personal monetary information and travel itinerary, is transmitted via the communication network to the administration device. The administration device coordinates the transfer of funds relating to the retail goods purchased, in addition to the delivery of the selected retail goods to the destination of the individual. The individual, upon arrival at their destination, can collect their purchased retail goods at a predetermined, pre-customs location. Using this system, an individual is provided with the opportunity to make “duty free” or “tax free” purchases during international travel, without the need for transporting the purchases on the mode of transportation, for example an aircraft.

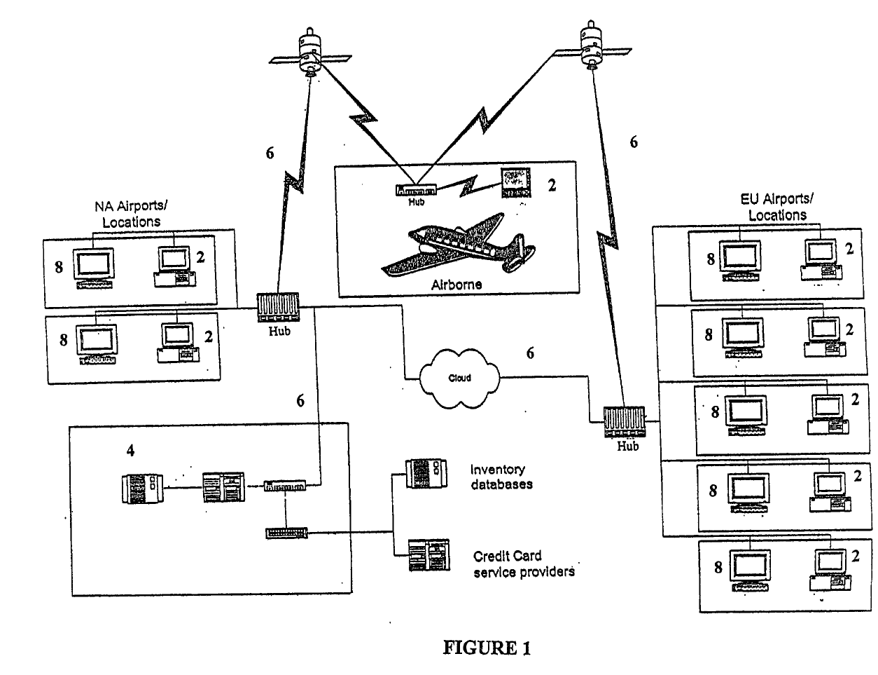

FIG. 1 illustrates a system schematic according to one embodiment of the present invention as it may be used in the air transportation industry. A browsing device 2, located either on an aircraft or at a ground location prior to departure of the traveller, is used to view, identify and select retail goods by the traveller. The browsing device 2 communicates with the administration device 4 using one or more communication networks 6, which may be hardwired networks or a wireless networks or a combination thereof, in order to transfer information relating to the traveller's selection and method of payment for the retail goods. The administration device 4 processes the purchase request of the traveller, for example, processing the payment method with financial institutions, checking inventory at a destination point for the selected product and coordinating delivery of the retail product to the destination of the traveller. The functions performed at the destination point can be additionally coordinated by a destination device 8. Upon arrival at their destination the traveller may claim their “duty free” purchase at a location prior to entry into customs. In this manner a traveller can take advantage of “duty free” shopping during international travel while not having to personally transport the purchased retail goods from the departure point to the destination point.

Browsing Devices

The one or more browsing devices can take a number of different forms, however each form of these devices enables an individual (traveller) interactivity with the system, therefore allowing an individual to view, identify, and select products which they wish to purchase. A browsing device further provides a means for collecting financial information relating to the individual, wherein this information enables the monetary transactions to be performed in order to complete the sale of the products selected by the individual.

A browsing device comprises a processing unit, an input device, a display device and an interconnection mechanism to a communication network enabling connection to the other components of the system of the present invention. The processing unit provides the browsing device with its functionality and can be any type of processing unit as would be known to a worker skilled in the art. The input device can be any number of mechanisms for example a mouse, keyboard or may be integrated into the display device in the form of a “touch screen” system. A worker skilled in the art would understand a number of other input devices that would enable an individual to interact with a browsing device. The display unit provides the individual with a visual interface with the browsing device and may be for example a CRT, LCD or plasma display or any other type of display device as would be known to a worker skilled in the art. As previously mentioned, the display unit and the input device may be integrated into one system thereby providing a “touch screen” type system enabling the display and input of information by an individual. The interconnection mechanism associated with a browsing device can enable wireless or wired interconnection to the communication network associated with the system. For example, the interconnection mechanism may be a RF transmitter, an ethernet connection, or any other type of interconnection mechanism as would be known to a worker skilled in the art. Optionally, the browsing device may have incorporated therein a printing device, enabling the creation of a receipt for an individual, which may be used as a claim check for collection of the purchased items at the destination location.

In one embodiment, a browsing device can take the form of a kiosk or public access terminal, which could be situated at strategic locations for use by travellers using the system according to the present invention. These strategic locations can be, for example, at an airport in the departure lounge or elsewhere, or optionally at a location removed from the point of departure, for example proximate to a travel agency. Other strategic locations for the placement of this form of browsing device would be known to a worker skilled in the art and the evaluation of a potential location may be based on the likelihood of use by an international traveller.

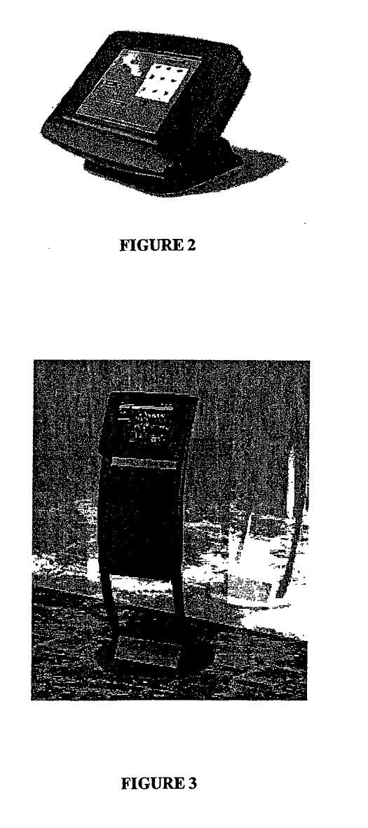

FIG. 2 illustrates a Public Access Terminal (PAT) used in accordance with one embodiment of the present invention and FIG. 3 illustrates the PAT of FIG. 2 mounted on a stand. A representative PAT model that can be used in accordance with one embodiment of the present invention is the IBM Model 988-W15. This model has the following features:

Rugged, contour-moulded plastic enclosure;

Colour LCD display with Elo Touchsystems heavy use, resistive touch screen;

Pentium III 866 MHz processor with 128 MB RAM and 6 GB fixed disk;

10/100 Mbps. Ethernet, RJ45 port;

Total of 4 RS 232 ports (3 are available), 1 parallel port, 2 USB ports to allow future expansion to connect to additional peripherals;

2-track card reader;

Basic countertop configuration with external printout option or free-standing frame that can also house up to three 8.5″ wide roll-fed thermal printers for redundancy;

Microsoft™ Windows™, Internet Explorer™ and IBM™ Net CDS licensed software pre-loaded.

In accordance with one embodiment of the present invention, a free standing PAT such as the one shown in FIG. 3 may be placed in airports and/or other international travel locations where travel retail shopping is sanctioned. A PAT may operate using transmission control protocol/internet protocol (TCP/IP) or wireless application protocol (WAP) in order to access to the Internet. A PAT supports browser technology, and uses SSL, HTTPS (128 bit encryption security) and accepts digital certificates such as those provided by Verisign™.

In one embodiment, enterprise management tools such as IBM™ Consumer Device Services (CDS) provides diagnostics, error handling, system management and client functions to deliver high availability. Remote monitoring can be provided using for example, standard Internet Explorer™ web browser viewing tools.

In one embodiment, in order to manage, monitor and measure the kiosk network, IBM™ provides an integrated package of software components designed for kiosk networks such as Kiosk Manager™ which is an HTML-based graphical tool for the remote monitoring of a network of kiosks.

In an alternate embodiment of the present invention, a browsing device can be a mobile unit that can be operated by a traveller during the transportation process, for example during a flight on an aircraft. For example, the browsing device may be a cellular phone, personal digital assistant (PDA), lap top computer, Blackberry™ or any type of mobile computing device as would be known to a worker skilled in the art. As would be appreciated by a worker skilled in the art, a number of the communication methods used by mobile units may interfere with electronic systems on board an aircraft. Therefore, it is important that the form of the interconnection mechanism which is associated with the browsing device of this embodiment does not have this undesirable affect. In one embodiment, the interconnection mechanism may enable interconnection with a hardwired system associated with an aircraft thereby providing interconnection with a communication network enabling connection with the other components of the system for enabling retail sales to international travellers.

In one embodiment of the present invention, a browsing device may have incorporated therein a complete catalogue of retail goods that are available for purchase using this system. In this manner, a browsing device may not have to retrieve a catalogue from the administration device prior to display to a traveller.

Administration Device

The administration device enables the processing of one or more purchase orders that are made by travellers using the system according to the present invention. The administration device may be a single computing device or a collection of interconnected computing devices providing this functionality. The one or more computing devices may be server based devices, for example, the administration device can be a Windows™-2000 or XP or similar server, wherein examples of the high-performance Windows™ 2000 or XP or similar machines that may be used are, IBM™ xSeries and HP™ lh. A worker skilled in the art would understand a number of other computing devices that may be used as the administration device in order that the desired functionality can be achieved.

The administration device is interconnected to one or more databases which may comprise information relating to, for example, product inventory and availability at destination sites of travellers, financial information relating to a traveller that desires to make a purchase, information relating to the destinations that are associated with the system and customer demographics including customer personal information and previous purchase information. In addition these databases may include information relating to access passwords for a plurality of travellers and system administrators, for example.

The tasks associated with the administration device may comprise but are not limited to electronically recording the initial customer interaction with the system using a browsing device, initiating and recording customer purchases; processing customer payment clearances and approvals with financial intermediaries, for example credit card companies or banking institutions; and completing customer purchase orders by fulfilling the order and coordinating the delivery of the purchased goods to the appropriate destination location for pick up by a traveller.

In one embodiment of the present invention, the administration device may further comprise a currency exchange module that enables conversion between currencies. For example, a particular traveller may request that the cost of the retail goods be displayed in the monetary value of their “home” currency, thereby possibly enabling them to better evaluate the potential savings associated with the purchase of the retail goods. This module may be updated with current exchange rates daily or hourly for example, thereby ensuring accuracy of the exchanges, wherein this updating procedure may be automatically initiated by the administration device or may be initiated by an operator. Optionally, a currency module may be incorporated into the browsing device.

In one embodiment of the present invention, the administration device may generate immediate payment to suppliers, airport management authorities, airlines and other modes of transport, in addition to financial intermediaries that authorise payments.

In one embodiment of the invention, more than one computing device forms the administration device, the computing devices contained in the administration device may be configured such that the computational load experienced by each of the computing devices can be balanced through the integration of an allocation procedure for example, Dynamic Server Allocation (DSA). The DSA subsystem defines a mechanism by which tasks are dynamically allocated to computing devices. This allocation is based on the availability and current load of a pre-determined set of computing devices dedicated to the administration device. DSA allows clients (browsing devices) to obtain their services from the most “available” computing device in an ad-hoc or dynamic basis. This configuration of the administration device allows for the seamless addition of an unlimited number of computing devices, thus enabling the number of browsing devices to increase simultaneously if so desired. For example, the administration device can incorporate a cluster of Windows 2000 or XP or similar servers. Examples of the high-performance Windows™ 2000 or XP or similar machines that may be used in one embodiment of the present invention are, IBM™ xSeries and HP™ lh.

Communication Network

The communication network interconnects the one or more browsing devices with the administration device thereby enabling the transfer of information therebetween. In one embodiment of the invention, the communication network may be a hardwired system, a wireless system or a combination thereof For example, the communication network may employ radio frequency (RF) emissions, microwave, ethernet, satellite, public or private switched telephone networks (PSTN), for example, the Internet, a wide area network (WAN) or a local area network (LAN), or any other form of a communication network as would be known to a worker skilled in the art.

In one embodiment of the invention, the communication network must enable the communication between browsing devices on board a transportation vehicle, for example an aircraft, and the administration device which is located at a terrestrial location. For example the communication network which is installed on an aircraft may provide interconnection between a browsing device and an on-board cabin file server that is programmed to deliver Internet services over a satellite communications system. This type of communication network may provide a traveller with seamless in-flight connectivity, and may be supported by ground stations and customer care centres, for example Connexion by Boeing™.

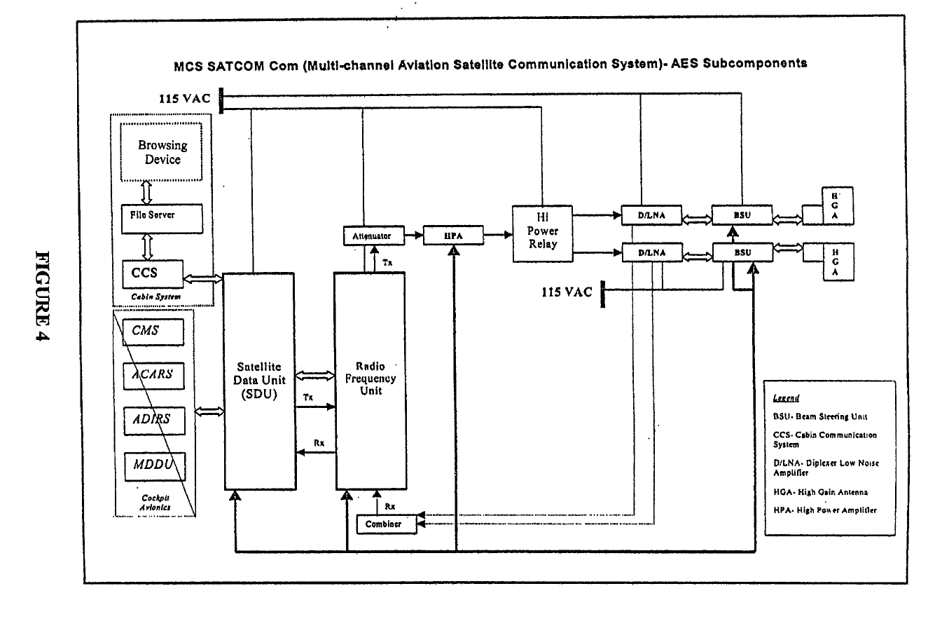

In one embodiment of the invention, FIG. 4 is a schematic diagram of a multi-channel aviation satellite communication system which is a module that may be operating on an aircraft in order to provide communication between a browsing device and the administration device. FIG. 4 is a generic representation and may be considered for a permanent (hard-wired), semi-permanent or temporary installation on an aircraft.

FIG. 4 does not illustrate the non-airborne avionics components consisting of the space segment (i.e. satellite network), the Ground Earth Station (GES) and the Public and Private voice and data terrestrial telecommunications network (PSTN). The space segment comprises satellites in geo-synchronous orbit, which provide air-ground packet switch data and voice communication. The satellites work as communication transponders to support links to and from the aircraft as well as to ground stations. Each GES can communicate both terrestrially and to aircraft through these satellites. It uses submarine cable systems and microwave communication links to communicate to all destinations serviced by airlines.

The multi-channel aviation satellite communication system illustrated in FIG. 4 provides bi-directional mobile voice and data communications. This communication system accepts data and voice communication from various inputs. It encodes and modulates this information at appropriate frequency carriers which the GES can decode. The current standard interfaces include among other avionic communication systems (ACARS, IRS, MDDU, MCDU) the CCS (Cabin Communication System).

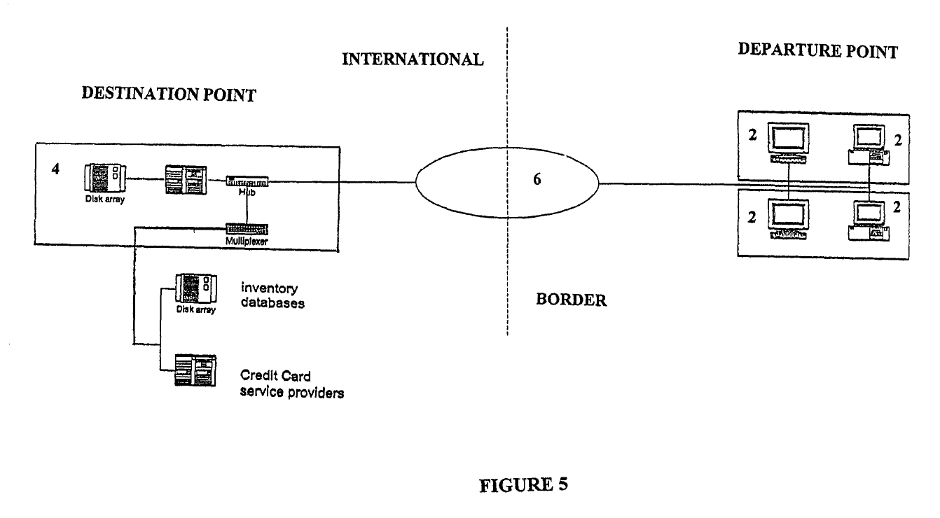

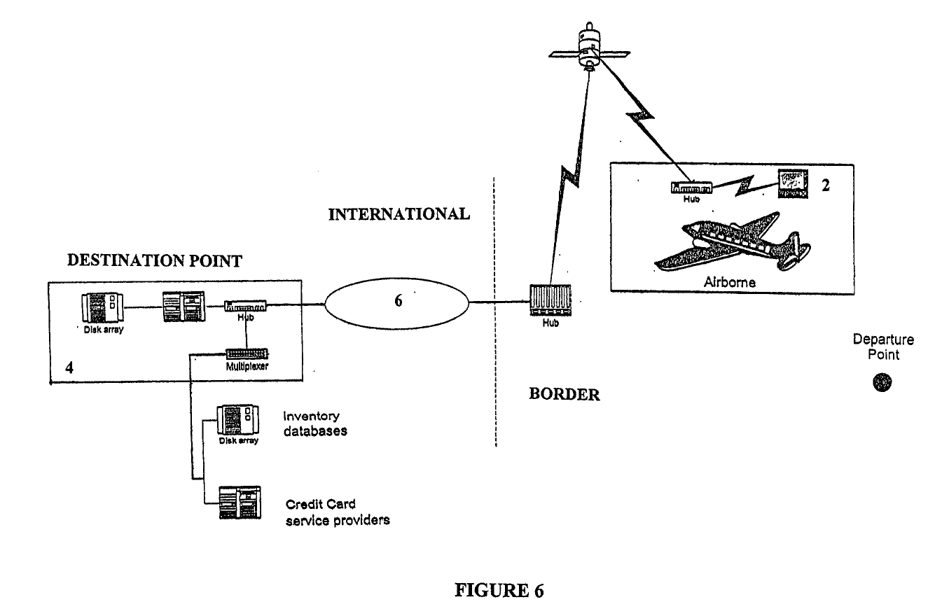

There are several configurations of the components that are possible according to the present invention while providing the functionality of the system. In one embodiment of the present invention, as illustrated in FIGS. 5 and 6, the administration device can be located at the destination of the traveller. In this configuration, the administration device may be inherently connected to the inventory database of the retail goods for this location. In addition, the administration device may further coordinate the distribution of purchased items to the appropriate traveller(s) at this destination location.

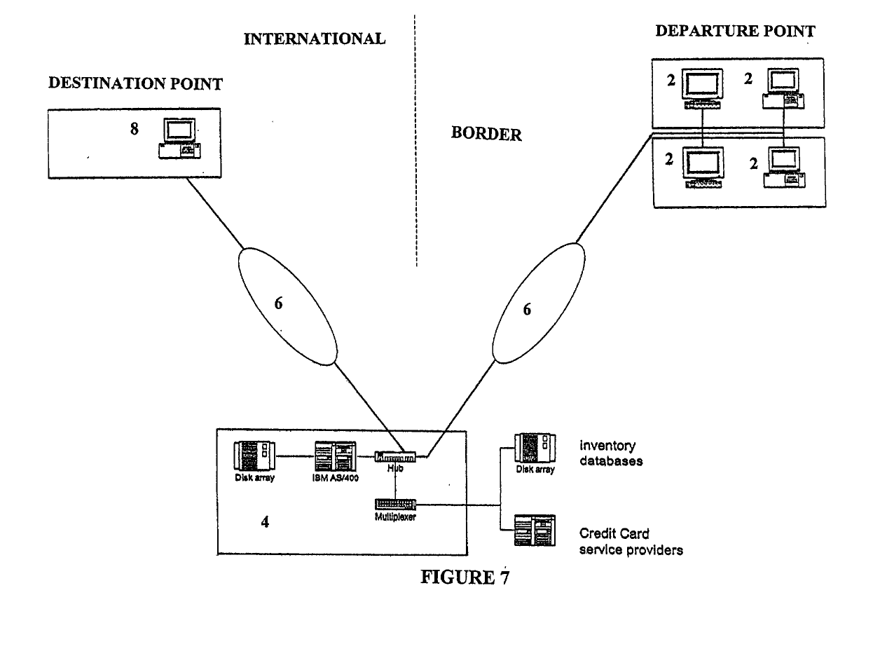

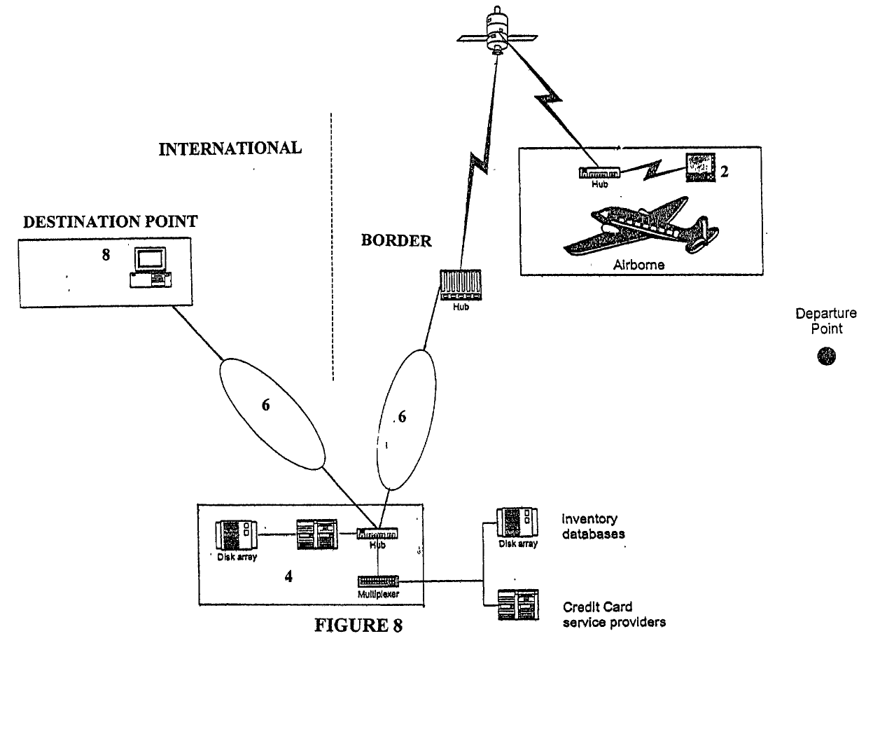

In an alternate embodiment, as illustrated in FIGS. 7 and 8, the administration device can be located at an arbitrary location. In this configuration, the administration device can be interconnected, via a communication network, to an additional computing device, termed the destination device. The destination device evaluates the inventory of the retail goods at the destination location, in addition to coordinating the distribution of purchased retail goods to the appropriate traveller(s) at this destination location. In this configuration, a single administration device may provide the functionality of the system to a number of destination locations.

In one embodiment of the present invention, the architecture of the system comprises a main data repository, proxy/cache servers at each major overseas point (for example one per continent) and Public Access Terminals (PATs) placed within airport terminals. Standard dialup or web-connected infrastructure links all components in a secure and reliable manner.

Destination Device

The destination device provides a means for managing the inventory at a destination location in addition to the coordination of the distribution of purchased retail goods to the appropriate traveller(s) at this destination location. The destination device may be a single computing device, a collection of interconnected computing devices or data receiving devices, for example, facsimile machine, enabling this functionality. The one or more computing devices may be server based devices, for example, the administration device can be a Windows™ 2000 or XP or similar server, wherein examples of the high-performance Windows™ 2000 or XP or similar machines that may be used are, IBM™ xSeries and HP™ lh. A worker skilled in the art would understand a number of other computing devices which may be used as the administration device in order that the desired functionality can be achieved. In one embodiment of the invention the destination device is interconnected to one or mores databases which include information relating to the retail goods at the destination point.

Method of Use

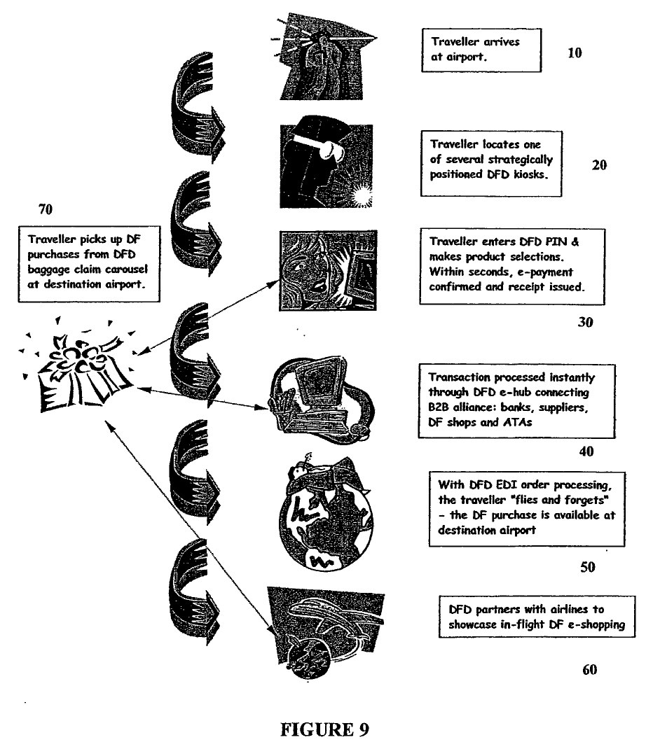

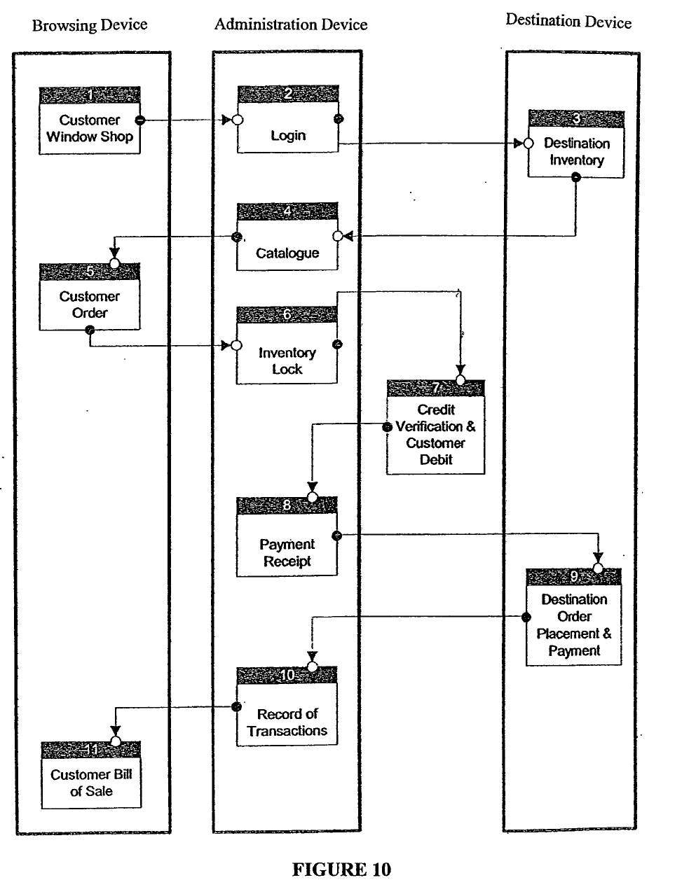

FIG. 9 is a schematic flowchart of the steps undertaken by a purchaser when purchasing travel retail goods in accordance with one embodiment of the present invention. FIG. 10 illustrates a data flow diagram for the steps identified in FIG. 9.

At step 10, a traveller arrives at an airport. It should be noted that the physical location where order entry takes place is arbitrary. It could be proximate to the departure port (such as an airport), or at a travel agent office, or at some other location.

At step 20, the traveller locates one of several strategically positioned browsing devices, or possibly any web-access point used in accordance with the present invention. See FIG. 2 for a representative example of such browsing device according to this embodiment.

At step 30, the traveller enters a Personal Identification Number (PIN) and is provided with a range of product selections. The traveller then makes a product selection and identifies a point of delivery for the travel retail goods (usually the point of arrival for the traveller). Through use of the administration device, there is then a confirmation of the delivery, the browsing device then receives payment details from the purchaser. An electronic claim ticket may then issued to the traveller as a receipt.

At step 40, the transaction is then processed through the administration device which connects various members of the business-to-business alliance, for example banks, suppliers, travel retail shops, passenger transport service providers and airport management authorities.

At step 50, the travel retail purchase is made available at the point of arrival of the traveller.

Optionally, at step 60, a traveller is showcased on-board travel retail shopping selections during the flight.

At step 70, the traveller picks up the travel retail purchase at the point of arrival, for example at a pick-up location which is in the proximity of a baggage claim carousel.

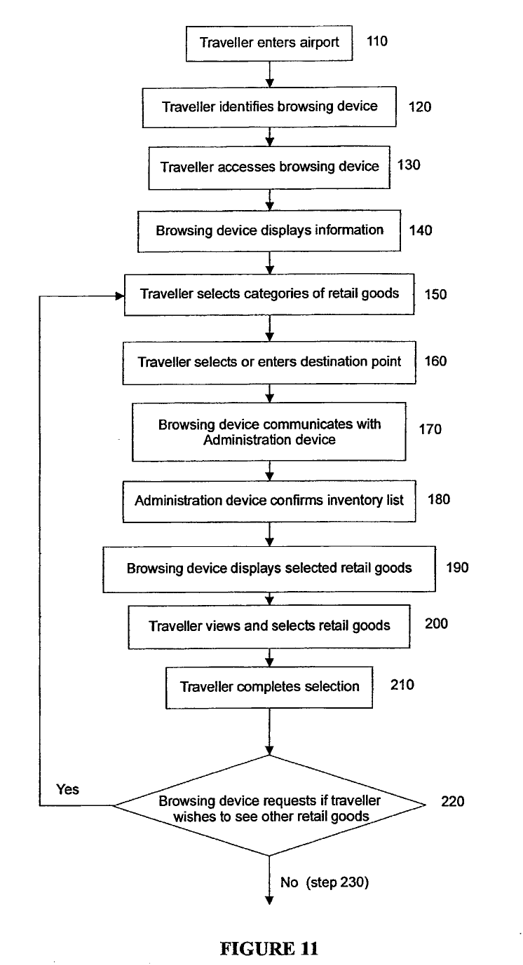

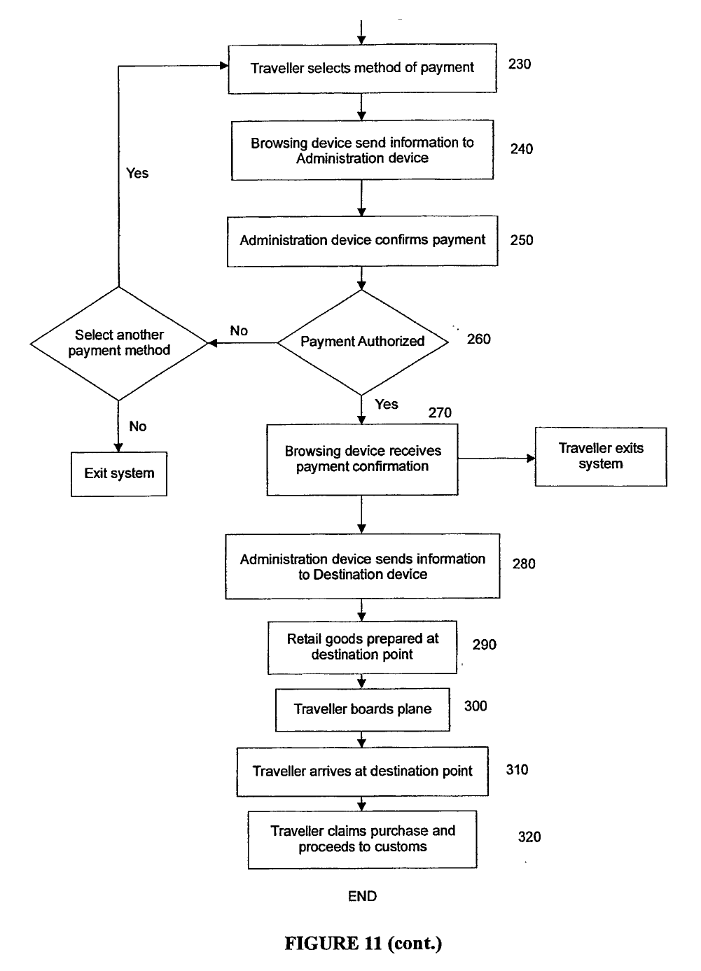

FIG. 11 illustrates a schematic flowchart of the various steps undertaken by a traveller when purchasing retail goods in accordance with one embodiment of the present invention. In this embodiment a browsing device is located at the departure point, for example an airport, the administration device is located at a remote location and the destination device is located at a destination point.

At step 110, the traveller enters the airport terminal.

At step 120, the traveller identifies a browsing device located within an area of the airport terminal. For example, the browsing device may be located in a general public area of the airport terminal or within a security area which may be located proximate to a point of boarding an aircraft or other transport mode.

At step 130, the traveller accesses a browsing device through an identification process. Such a process may include the identification of, for example, an airline ticket number, a credit card, a boarding pass or a personal identification number (PIN).

At step 140, the browsing device displays information to the traveller for example categories of goods available through the “duty free” system of the present invention. These categories may include, for example, liquor, perfumes, clothing, jewelry etc.

At step 150, the traveller selects one or more categories of retail goods to be displayed on the browsing device.

At step 160, the traveller enters or selects a destination point using the browsing device.

At step 170, the browsing device using the communication network, communicates with the administration device transferring information relating to this selection.

At step 180, the administration device using the communication network confirms an inventory list of each good to be displayed to the traveller. In one embodiment, each destination device may periodically or instantaneously update its inventory and subsequently transmit this information to the administration device. The transmission of the updated inventory information to the administration device by a destination device may occur periodically or instantaneously for example. Alternately, the administration device may access the destination device requesting a current inventory status when required.

At step 190, the administration device using the communication network communicates with the browsing device in order to display retail goods within a specified category as selected by the traveller. It should be noted for example, that only retail goods having an inventory greater than zero may be displayed to the traveller. For example, retail goods not in stock at the selected destination point will not be displayed to the traveller.

At step 200, the traveller views and selects retail goods to be purchased using the browsing device.

At step 210, the traveller indicates the completion of the selection of retail goods to be purchased using the browsing device.

At step 220, the browsing device requests if the traveller wishes to view retail goods from other categories.

At step 220a—If the traveller requests to see retail goods from other categories then return to step 150, if not proceed to step 230.

At step 230, the traveller selects a method of payment as presented by the browsing device which may include for example, credit card or debit card, or alternate payment method, for example cash or PayPal™.

At step 240, the browsing device using the communication network transmits a list of selected retail goods, the destination point and the method of payment to the administration device.

At step 250, the administration device using the communication network communicates with the financial institutions enabling authorization of payment for the selected retail goods through the method of payment chosen by the traveller.

At step 260, if the method of payment for the purchase of retail goods is denied, the browsing device may request the traveller selects another method of payment or that the traveller exit the system.

At step 260a—If traveller requests another method of payment, then return to step 230, if not then traveller exits the system.

At step 270, Upon receiving confirmation from the financial institution authorizing payment, the administration device using the communication network communicates with the browsing device in order to confirm payment and subsequently provides a confirmation number, or a receipt to the traveler for retrieval of the purchased retail goods at the destination point. The traveller may also use their boarding pass as a claim ticket for example.

At step 280, the administration device using the communication network communicates with the destination point to indicate a list of goods purchased by the traveller.

At step 290, the destination device prepares a list of goods purchased by the traveler for pick-up upon arrival at destination point.

At step 300, the traveller boards the aircraft and travels to the destination point

At step 310, the traveller arrives at destination point and picks up purchased goods from a “duty free” counter located at a position prior to entering customs.

At step 320, the traveller proceeds to customs with purchased goods.

In another embodiment of the invention, the administration device is located at the destination point and therefore may incorporate the functionality of the destination device as previously described.

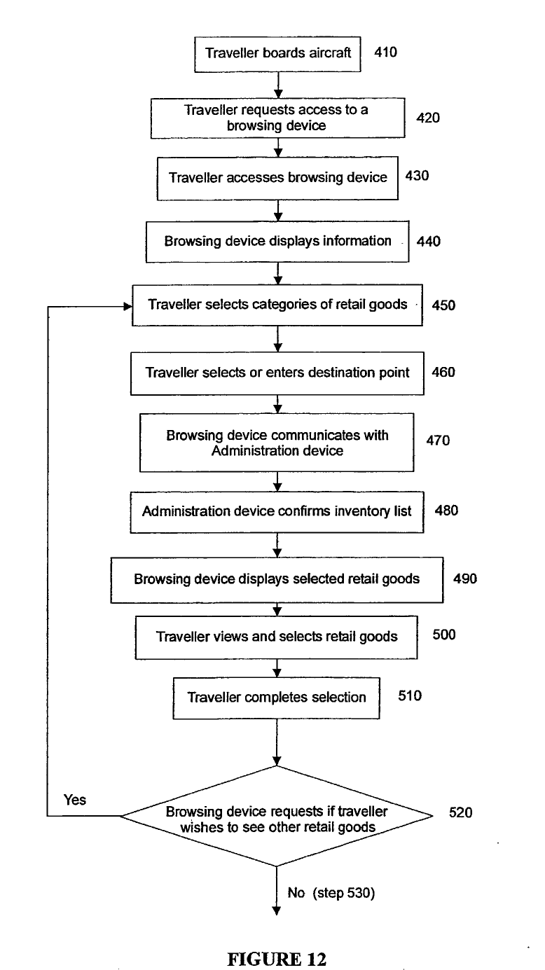

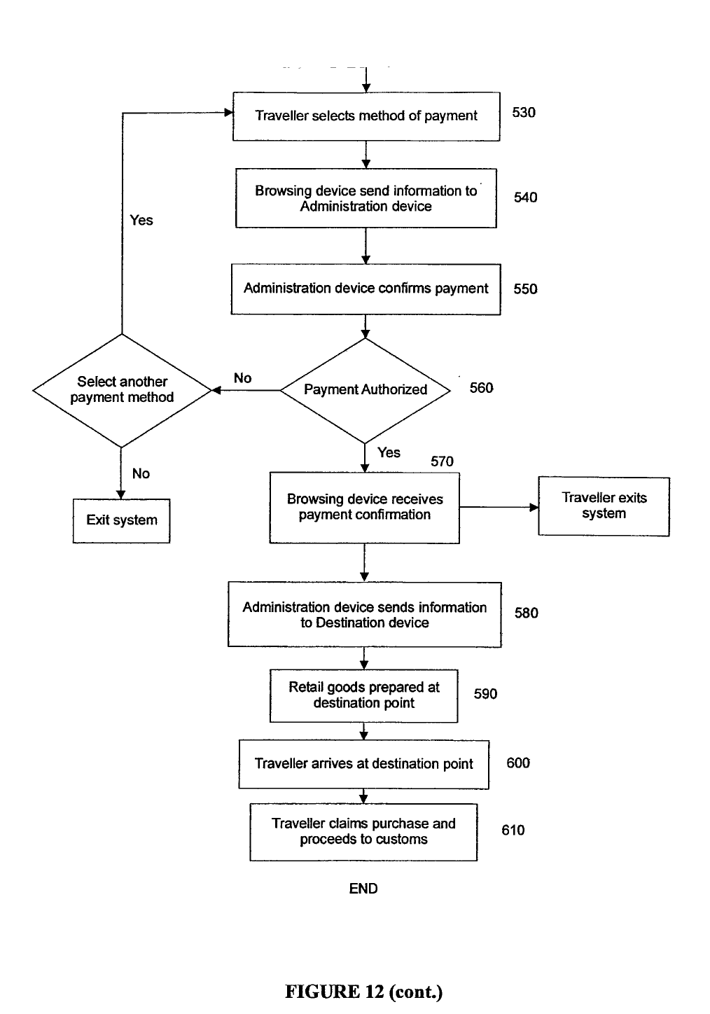

FIG. 12 illustrates a schematic flowchart of the various steps undertaken by a traveller when purchasing retail goods in accordance with one embodiment of the present invention. In this embodiment the browsing device is located on board an aircraft, the administration device is located at a remote area and the destination device is located at a destination point.

At step 410, the traveller boards an aircraft.

At step 420, the traveller request access to a browsing device which may be located within close proximity of the traveller, for example, embedded within the back posture of the seat positioned in front of the traveller. The browsing device embedded within the seat may be removed and brought towards the traveller. The browsing device may also be portable and brought to the traveller upon request, for example.

At step 430, the traveller accesses browsing device through an identification process. Such a process may include the identification of, for example, an airline ticket number, a credit card, a boarding pass or a personal identification number (PIN).

At step 440, the browsing device displays information to traveller such as categories of goods available through the “duty free” system of the present invention. These categories may include, for example, liquor, perfumes, clothing, jewelry etc.

At step 450, the traveller selects one or more categories of retail goods to be displayed on the browsing device.

At step 460, the traveller enters or selects a destination point using the browsing device.

At step 470, the browsing device through a communication network communicates with the administration device transferring information relating to this selection.

At step 480, the administration device using a communication network confirms an inventory list of each good to be displayed to the traveller with a destination device (at the selected destination point). In one embodiment, each destination device may periodically or instantaneously update its inventory and subsequently transmit this information to the administration device. The transmission of the updated inventory information to the administration device by a destination device may occur periodically or instantaneously for example. Alternately, the administration device may access the destination device requesting a current inventory status when required.

At step 490, the administration device using a communication network communicates with the browsing device in order to display retail goods within specified category as selected by the traveller. It should be noted for example, that only retail goods having an inventory greater than zero may be displayed to the traveller. For example, all retail goods not in stock at the previously selected destination point may not be displayed to the traveller.

At step 500, the traveller views and selects retail goods to be purchased using the browsing device.

At step 510, the traveller indicates the completion of the selection of the retail goods to be purchased on the browsing device.

At step 520, the browsing device request if traveller wishes to view retail goods from other categories

At step 520a—If the traveller requests to see retail goods from other categories then return to step 450, if not proceed to step 530.

At step 530, the traveller selects a method of payment as presented by the browsing device which may be through credit cards or debit cards or alternate payment method, for example cash or PayPal™.

At step 540, the browsing device using a communication network transmits a list of selected retail goods, the destination point and the method of payment to the administration device.

At step 550, the administration device using a communication network communicates with the financial institutions enabling authorization of payment for purchase of selected retail goods through the method of payment chosen by the traveller.

At step 560, if the method of payment for the purchase of retail goods is denied, the browsing device may request traveller to select another method of payment or to exit the browsing system.

At step 560a—If traveller request other method of payment, then return to step 530, if not then traveller exits the system.

At step 570, upon receiving confirmation from financial institutions authorizing payment, the administration device using a communication network communicates with the browsing device in order to confirm payment and subsequently provides a confirmation number, or receipt to the traveller for retrieval of the purchased retail goods at the destination point. The traveller may also use their boarding pass as a claim ticket for example.

At step 580, the administration device using a communication network communicates with the destination device identifying a list of retail goods purchased by the traveller.

At step 590, the destination device prepares a list of retail goods purchased by the traveller for pick-up upon arrival at destination point.

At step 600, the traveller arrives at destination point and picks up purchased goods from a “duty free” prior to entering customs.

At step 610, the traveller proceeds to customs with purchased goods.

In another embodiment of the invention, the administration device is located at the destination point and therefore may incorporate the functionality of the destination device as discussed above.

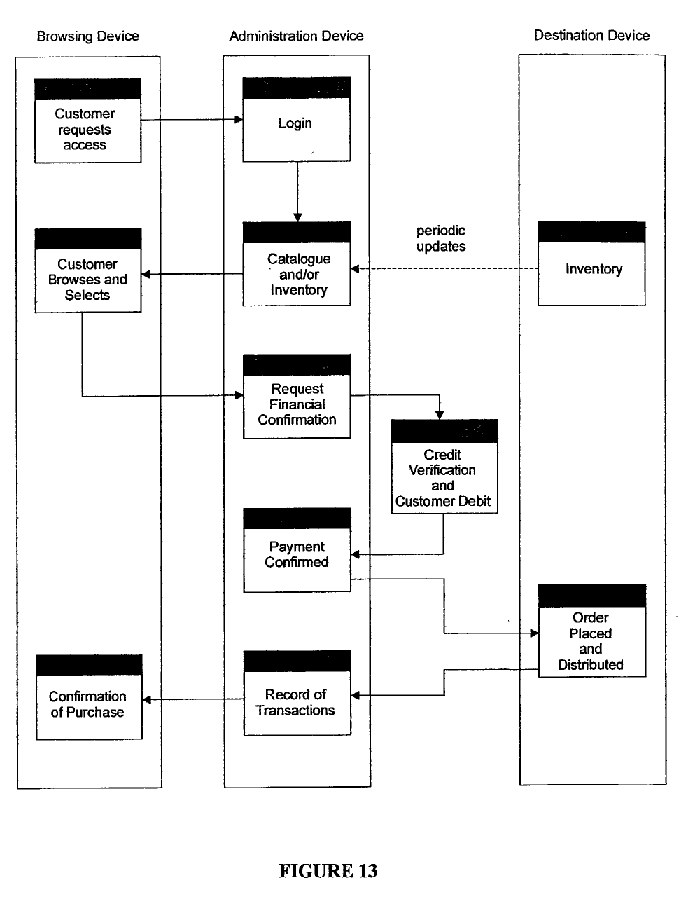

In one embodiment of the present invention, a sequence of interaction steps between a browsing device, the administration device and a destination device is illustrated in FIG. 13.

In one embodiment, market intelligence can be gathered through the one or more browsing devices which then could be sold to suppliers, transport, operators, airport shops, airport authorities, financial intermediaries and government agencies. Such market intelligence could include any one or more of: demographic profiles of travellers and destination preferences; product preferences, pre-sale dispositions and purchase behaviour; price and income elasticity of customer demand; international macro-trends in buyer behaviour; vital statistic for government demographers and custom agencies; traveller receptiveness (and purchase behaviour modification) to on-board multi-media promotion and kiosk banner advertising.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A system enabling the sale of retail goods to one or more individuals travelling from a departure point to a destination point, the system comprising:
a) one or more browsing devices enabling an individual to view, identify and select one or more retail goods for purchase;
b) an administration device for processing one or more purchase orders of the one or more individuals, the administration device being interconnected to one or more databases, the administration device being located at the destination point; and
c) a communication network for interconnecting the one or more browsing devices and the administration device;
wherein the departure point and the destination point are separated by one or more international borders and wherein the one or more individuals claim the purchased retail goods at a pre-customs location at the destination point.

2. The system according to claim 1, wherein the one or more databases comprise information relating to the retail good and monetary information of the one or more individuals.

3. The system according to claim 1, wherein the browsing device is selected from the group comprising, a public access terminal, a kiosk, a cellular phone, a personal digital assistant or a laptop computer.

4. The system according to claim 1, wherein the administration device is one or more server based computing devices.

5. The system according to claim 1, wherein the communication network is selected from the group comprising a radio frequency network, a microwave network, ethernet network, a satellite network or a public or private switched telephone network.

6. A system enabling the sale of retail goods to one or more individuals travelling from a departure point to a destination point, the system comprising:
a) one or more browsing devices enabling an individual to view, identify and select one or more retail goods for purchase;
b) a destination device enabling the distribution of purchased retail goods, the destination device being located at the destination point;
c) an administration device for processing one or more purchase orders of the one or more individuals, the administration device being interconnected to one or more databases, the one or more databases including information relating to monetary information of the one or more individuals and optionally relating to the retail goods, the administration device relaying information from the one or more browsing devices to the destination device, the administration device being located at a point removed from both the departure point and the destination point;
d) a first communication network for interconnecting the one or more browsing devices and the administration device;
e) a second communication network for interconnecting the administration device and the destination device;
wherein the departure point and the destination point are separated by one or more international borders and wherein the one or more individuals claim the purchased retail goods at a pre-customs location at the destination point.

7. The system according to claim 6, wherein the destination device is interconnected to one or more databases, wherein the one or more databases include information relating to the retail goods.

8. The system according to claim 6, wherein the one or more databases comprise information relating to the retail good and monetary information of the one or more individuals.

9. The system according to claim 6, wherein the browsing device is selected from the group comprising, a public access terminal, a kiosk, a cellular phone, a personal digital assistant or a laptop computer.

10. The system according to claim 6, wherein the administration device is one or more server based computing devices.

11. The system according to claim 6, wherein the first communication network is selected from the group comprising a radio frequency network, a microwave network or a satellite network.

12. The system according to claim 6, wherein the second communication network is selected from the group comprising a radio frequency network, a microwave network, an ethernet network, a satellite network or a public or private switched telephone network.

13. The system according to claim 6, wherein the destination device is a computing system or a facsimile system.

14. A kiosk for use in the sale of travel retail goods to a purchaser, the kiosk being proximate to a port at a point of departure for said purchaser, said kiosk comprising:
a) an input;
b) a display screen; and
c) communications means;
whereby upon the entering of an order for travel retail goods by the purchaser, data associated with the order is sent via the communication means for fulfillment at location B, location B being proximate to a port at a point of arrival for said purchaser.

15. A satellite communication device for use in the sale of travel retail goods to a purchaser, the satellite communication device being on-board a mode of transportation for said purchaser, said satellite communication device comprising:
a) an input;
b) a display screen; and
c) satellite communications means;
whereby upon the entering of an order for travel retail goods by the purchaser, data associated with the order is sent via the satellite communication means for fulfillment at location B, location B being proximate to a port at a point of arrival for said purchaser.

16. Computer readable medium storing processor executable instructions that when loaded at a kiosk or satellite communication device at location A adapt said kiosk or satellite communication device to,
a) display on a display screen a range of travel retail goods available for sale;
b) enable a selection by the purchaser of one or more of said range of travel retail goods;
c) confirm delivery at location B of the travel retail goods selected by the purchaser;
d) receive payment details from the purchaser;
e) forward order data to location B, the order data including details of the travel retail goods selected by the purchaser available from inventory a location B and the payment details received from the purchaser; and
f) provide the purchaser with an electronic claim ticket for use at location B.

17. A method of enabling the sale of travel retail goods comprising the steps of:
a) accepting from a purchaser an order for the sale of travel retail goods at location A; and
b) fulfilling the order for travel retail goods at location B, location B being proximate to a port at a point of arrival for said purchaser.

18. The method of claim 17 is whereby location A is proximate to a port at a point of departure for said purchaser.

19. The method of claim 18 wherein said port is an airport.

20. The method of claim 18 wherein said port is a seaport

21. The method of claim 18 wherein said port is a railway station.

22. The method of claim 17 whereby location A is proximate to an office of a travel agent.

23. The method of claim 17 whereby the order for the sale of travel retail good at location A is accepted through an Internet web site connected to the world wide web.

24. The method claim 17 whereby the order for the sale of travel retail goods at location A is accepted at a traveller order entry kiosk.

25. The method of claim 17 whereby the order for the sale of travel retail goods at location A is accepted on a wireless communication device.

26. The method of claim 17 wherein the step of accepting from a purchaser an order for the sale of travel retail goods at location A comprises the steps of
a) displaying a range of travel retail goods available for sale on a display screen;
b) enabling the selection by the purchaser of one or more of said range of travel retail goods;
c) confirming delivery of inventory at location B of the travel retail goods selected by the purchaser;
d) receiving payment details from the purchaser;
e) forwarding order data to location B, the order data including details of the travel retail goods selected by the purchaser available from inventory at location B and the payment details received from the purchaser; and
f) delivering a claim ticket to the purchaser for use at location B.

27. The method of claim 26 whereby the order data is forwarded to location B via the Internet.

28. The method of claim 26 whereby the order data is forwarded to location B via a wireless Wide Area Network (WAN).

29. The method of claim 26 whereby the order data is forwarded to location B via a wireless Local Area Network (LAN).

30. A method of enabling the sale of travel retail goods comprising the steps of:
a) accepting from a purchaser an order for the sale of travel retail goods onboard a mode of transportation travelling from a point of departure to a point of arrival; and
b) fulfilling the order for travel retail goods at the point of arrival for said mode of transportation.

31. The method of claim 30 whereby said mode of transportation is an airplane.

32. The method of claim 30 whereby said mode of transportation is a ship

33. The method of claim 30 whereby said mode of transportation is a train.

34. The method of claim 30 whereby the order for the sale of travel retail goods onboard a mode of transportation is accepted on an on-board satellite communications device.

35. The method of claim 30 wherein the step of accepting from a purchaser an order for the sale of travel retail goods on-board a mode of transportation comprises the steps of:
a) displaying on a display screen a range of travel retail goods available for sale;
b) enabling a selection by the purchaser of one or more of said range of travel retail goods;
c) confirming deliver of inventory at location B of the travel retail goods selected by the purchaser;
d) receiving payment details from the purchaser;
e) forwarding order data to location B, the order data including details of the travel retail goods selected by the purchaser available from inventory at location B and the payment details received from the purchaser; and
f) providing the purchaser with an electronic claim ticket for use at location B.

36 The method of claim 35 whereby the order data is forwarded to location B via satellite.
